(19) United States
(12) Patent Application Publication
(10) Pub. No.: US 2007/0093737 A1
(43) Pub. Date: Apr. 26, 2007

(54) Water flush type massaging device

(76) Inventors: Wen-Ching Lee, Yung Kang (TW); David Tsai, Wu Ku Hsiang (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/258,513

(22) Filed: Oct. 25, 2005

(51) Int. Cl. A61H 9/00

(52) U.S. Cl. 601/148; 601/160; 601/DIG. 20

(57) ABSTRACT

A massaging device includes a main body, a massaging member, a rotation member, a retaining ring, a protective hood, a motor, and a cover. Thus, the massaging device provides a soft massaging effect in a water flush manner without applying an excessive force on a user, thereby efficiently producing a comfortable sensation to the user. In addition, the massaging device can function as an individual massager and can also be mounted on other massager to provide a massaging effect, thereby enhancing the versatility of the massaging device.

### BACKGROUND OF THE INVENTION

1. Field of the Invention

The present invention relates to a massaging device, and more particularly to a water flush type massaging device.

2. Description of the Related Art

A conventional massaging device is used to massage a user's body so as to provide a comfortable sensation to the user. However, the conventional massaging device is often made of plastic material, so that if the force applied on the user's body is too large during the massaging process, the excessive force may hurt the user's body, thereby causing inconvenience to the user when operating the massaging device.

### SUMMARY OF THE INVENTION

In accordance with the present invention, there is provided a massaging device, comprising a main body, a massaging member mounted on a first end of the main body and having an inside containing fluid therein, a rotation member rotatably mounted in the main body to drive the fluid in the massaging member, and a motor mounted in the main body and connected to the rotation member to rotate the rotation member.

The primary objective of the present invention is to provide a water flush type massaging device.

Another objective of the present invention is to provide a massaging device that provides a soft massaging effect in a water flush manner without applying an excessive force on a user, thereby producing a comfortable sensation to the user.

A further objective of the present invention is to provide a massaging device that can function as an individual massager and can also be mounted on other massager to provide a massaging effect, thereby enhancing the versatility of the massaging device.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a massaging device in accordance with the preferred embodiment of the present invention.

FIG. 2 is a plan cross-sectional assembly view of the massaging device as shown in FIG. 1.

FIG. 3 is a schematic operational view of the massaging device as shown in FIG. 1 in use.

FIG. 4 is a schematic operational view of the massaging device as shown in FIG. 1 in use.

### DETAILED DESCRIPTION OF THE INVENTION

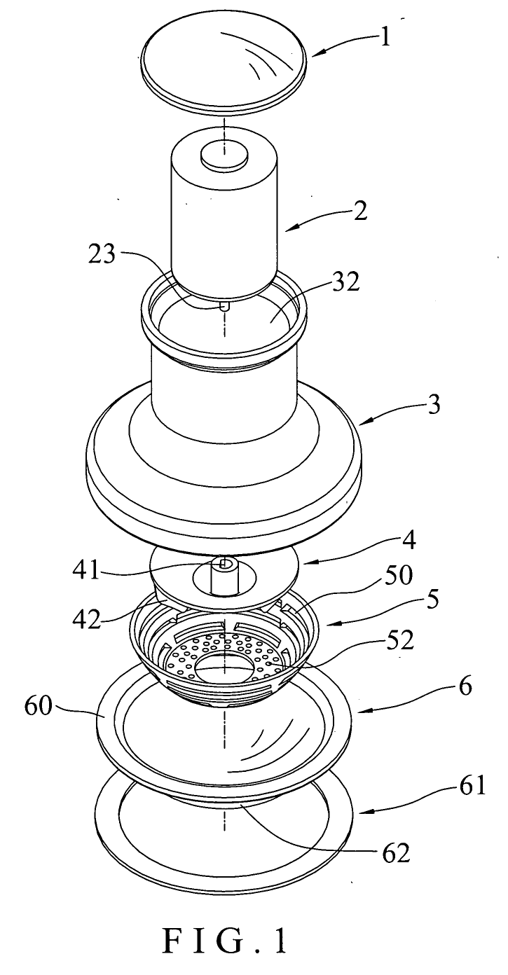

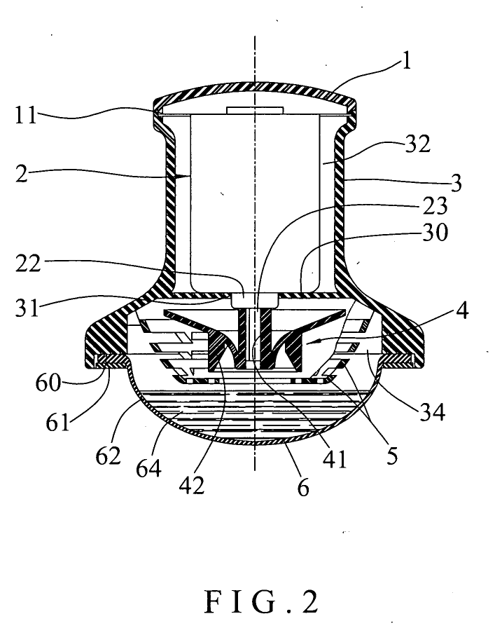

Referring to the drawings and initially to FIGS. 1-3, a massaging device in accordance with the preferred embodiment of the present invention comprises a main body 3, a massaging member 6 mounted on a first end of the main body 3 and having an inside containing fluid 64 therein, a rotation member 4 rotatably mounted in the main body 3 to drive the fluid 64 in the massaging member 6 to produce a turbulent flow in the massaging member 6, a retaining ring 61 secured to the first end of the main body 3 and rested on a periphery of the massaging member 6 to retain the massaging member 6 on the main body 3, a protective hood 5 mounted in the main body 3 and located between the rotation member 4 and the massaging member 6 to encompass and protect the rotation member 4, a motor 2 mounted in the main body 3 and connected to the rotation member 4 to rotate the rotation member 4, and a cover 1 mounted on a second end of the main body 3 to cover the motor 2.

The cover 1 has a periphery formed with a protruding piece 11 inserted into the second end of the main body 3 to secure the cover 1 to the main body 3.

The main body 3 has an inside formed with a support wall 30 which defines the inside of the main body 3 into a first chamber 32 to receive the motor 2 and a second chamber 34 to receive the rotation member 4 and the protective hood 5. The support wall 30 of the main body 3 has a through hole 31 connected to the first chamber 32 and the second chamber 34.

The motor 2 is a power motor and has an end provided with a protruding rotation seat 22 extended through the through hole 31 of the main body 3 and a rotation shaft 23 protruded outward from the rotation seat 22.

The rotation member 4 is a disk having a hill shape. The rotation member 4 is rotatably mounted on the rotation seat 22 of the motor 2 and has an inside formed with a shaft hole 41 secured on the rotation shaft 23 of the motor 2, so that the rotation member 4 is rotated with the rotation shaft 23 of the motor 2 simultaneously. The rotation member 4 has a periphery provided with a plurality of blades 42 to drive the fluid 64 in the massaging member 6.

The protective hood 5 has a substantially conic shape. The protective hood 5 has a periphery formed with a plurality of elongated slots 50 to allow passage of the fluid 64 in the massaging member 6 and a bottom wall formed with a plurality of circular holes 52 to allow passage of the fluid 64 in the massaging member 6.

The massaging member 6 is a substantially arc-shaped hood made of soft rubber material. The massaging member 6 has a convex massaging surface 62 protruding outward from the main body 3. The periphery of the massaging member 6 is formed with an outwardly extended annular flange 60 rested on the retaining ring 61. The inside of the massaging member 6 is connected to the second chamber 34 of the main body 3.

In operation, when the rotation shaft 23 of the motor 2 is rotated, the rotation member 4 is rotated with the rotation shaft 23 of the motor 2 simultaneously, so that the blades 42 of the rotation member 4 are rotated to drive the fluid 64 in the massaging member 6 to produce a turbulent flow in the massaging member 6. Thus, the massaging surface 62 of the massaging member 6 produces vibration by the turbulent flow in the massaging member 6 so as to provide a massaging effect.

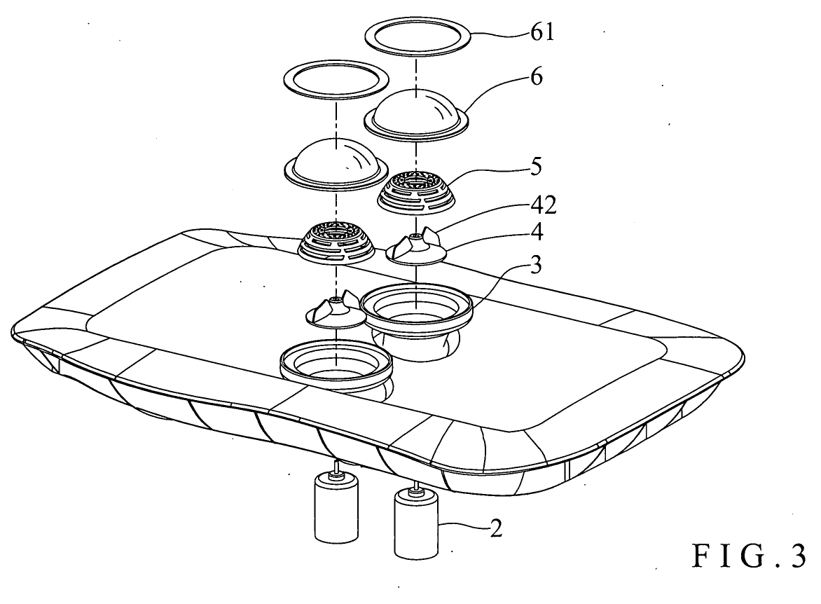

Referring to FIG. 3, the massaging device is mounted on a body massager to provide a massaging effect.

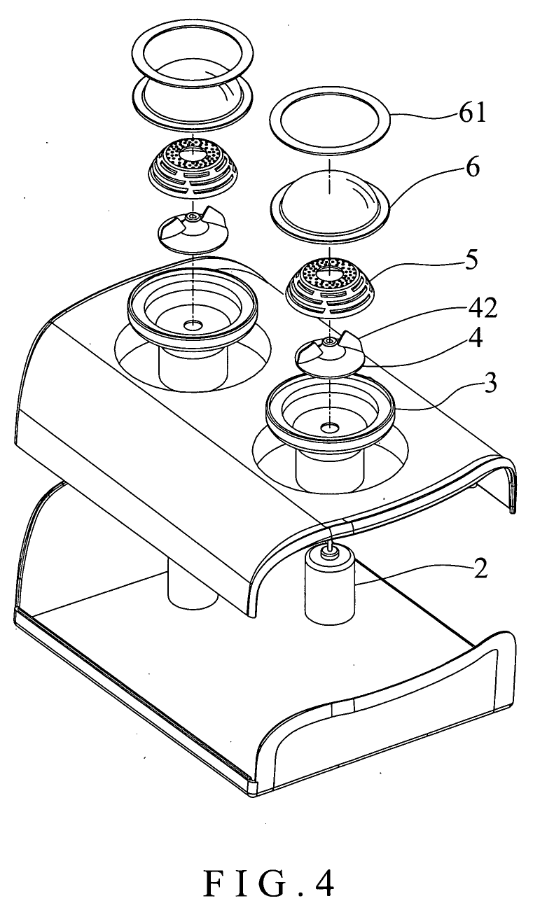

Referring to FIG. 4, the massaging device is mounted on a foot massager to provide a massaging effect.

Accordingly, the massaging device provides a soft massaging effect in a water flush manner without applying an excessive force on a user, thereby producing a comfortable sensation to the user. In addition, the massaging device can function as an individual massager and can also be mounted on other massager to provide a massaging effect, thereby enhancing the versatility of the massaging device.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A massaging device, comprising:
a main body;
a massaging member mounted on a first end of the main body and having an inside containing fluid therein;
a rotation member rotatably mounted in the main body to drive the fluid in the massaging member;
a motor mounted in the main body and connected to the rotation member to rotate the rotation member.

2. The massaging device in accordance with claim 1, wherein the rotation member drives the fluid in the massaging member to produce a turbulent flow in the massaging member.

3. The massaging device in accordance with claim 1, further comprising a retaining ring secured to the first end of the main body and rested on a periphery of the massaging member to retain the massaging member on the main body.

4. The massaging device in accordance with claim 3, wherein the periphery of the massaging member is formed with an outwardly extended annular flange rested on the retaining ring.

5. The massaging device in accordance with claim 1, further comprising a protective hood mounted in the main body and located between the rotation member and the massaging member to encompass and protect the rotation member.

6. The massaging device in accordance with claim 5, wherein the protective hood has a substantially conic shape.

7. The massaging device in accordance with claim 5, wherein the protective hood has a periphery formed with a plurality of elongated slots to allow passage of the fluid in the massaging member.

8. The massaging device in accordance with claim 5, wherein the protective hood has a bottom wall formed with a plurality of circular holes to allow passage of the fluid in the massaging member.

9. The massaging device in accordance with claim 1, further comprising a cover mounted on a second end of the main body to cover the motor.

10. The massaging device in accordance with claim 9, wherein the cover has a periphery formed with a protruding piece inserted into the second end of the main body to secure the cover to the main body.

11. The massaging device in accordance with claim 5, wherein the main body has an inside formed with a support wall which defines the inside of the main body into a first chamber to receive the motor and a second chamber to receive the rotation member and the protective hood.

12. The massaging device in accordance with claim 11, wherein the support wall of the main body has a through hole connected to the first chamber and the second chamber, and the motor has an end provided with a protruding rotation seat extended through the through hole of the main body and a rotation shaft protruded outward from the rotation seat.

13. The massaging device in accordance with claim 12, wherein the rotation member is rotatably mounted on the rotation seat of the motor and has an inside formed with a shaft hole secured on the rotation shaft of the motor, so that the rotation member is rotated with the rotation shaft of the motor simultaneously.

14. The massaging device in accordance with claim 1, wherein the rotation member is a disk having a hill shape.

15. The massaging device in accordance with claim 1, wherein the rotation member has a periphery provided with a plurality of blades to drive the fluid in the massaging member.

16. The massaging device in accordance with claim 1, wherein the motor is a power motor.

17. The massaging device in accordance with claim 1, wherein the massaging member is a substantially arc-shaped hood made of soft rubber material.

18. The massaging device in accordance with claim 1, wherein the massaging member has a convex massaging surface protruding outward from the main body.

19. The massaging device in accordance with claim 11, wherein the inside of the massaging member is connected to the second chamber of the main body.
